(19) United States
(12) Patent Application Publication
(10) Pub. No.: US 2015/0213700 A1
(43) Pub. Date: Jul. 30, 2015

(54) Personal Emergency Response System

(71) Applicant: Herman Sybrecht Veenstra, Amsterdam (NL)

(72) Inventor: Herman Sybrecht Veenstra, Amsterdam (NL)

(21) Appl. No.: 14/610,400

(22) Filed: Jan. 30, 2015

Related U.S. Application Data
(60) Provisional application No. 61/933,736, filed on Jan. 30, 2014.

(51) Int. Cl. G08B 21/02

(52) U.S. Cl. CPC G08B 21/02

(57) ABSTRACT

An embodiment of an emergency notification system includes a signaling device. The signaling device includes a first activatable sensing device, a second activatable sensing device, and a transmitter communicatively coupled to the first and second sensing devices. The transmitter is configured to transmit a first signal in response to activation by a user of both the first and second sensing devices. The system further includes a computer-readable medium on which are stored instructions that, when executed by a processor of an electronic device including a receiver and a transceiver, enable the electronic device to perform a method comprising the steps of receiving the first signal from the transmitter, and in response to receiving the first signal, transmitting a second signal over a wireless network to a predetermined recipient.

### PRIORITY CLAIM

The present application claims priority from U.S. Provisional Application No. 61/933,736, filed Jan. 30, 2014, which is hereby incorporated by reference as if fully set forth herein.

### BACKGROUND OF THE INVENTION

The wide spread use of mobile telephones has decreased the emergency response time of public emergency services, such as fire, police and rescue departments, as more and more passing motorists are able to dial the service number of such services shortly after an emergency situation arises. However, for certain emergencies it is not always safe or possible for the victim to utilize their mobile telephone to call for assistance.

### SUMMARY OF THE INVENTION

A first embodiment of an emergency notification system includes a signaling device. The signaling device includes a first activatable sensing device, a second activatable sensing device, and a transmitter communicatively coupled to the first and second sensing devices. The transmitter is configured to transmit a first signal in response to activation by a user of both the first and second sensing devices. The system further includes a computer-readable medium on which are stored instructions that, when executed by a processor of an electronic device including a receiver and a transceiver, enable the electronic device to perform a method including the steps of receiving the first signal from the transmitter, and in response to receiving the first signal, transmitting a second signal over a wireless network to a predetermined recipient.

A second embodiment also includes a signaling device. The signaling device includes a first activatable sensing device and a transmitter communicatively coupled to the first sensing device. The transmitter is configured to transmit a first signal in response to activation by a user of the first sensing device. The system further includes a computer-readable medium on which are stored instructions that, when executed by a processor of an electronic device including a receiver, a second activatable sensing device and a transceiver, enable the electronic device to perform a method including the steps of receiving the first signal from the transmitter, and in response to receiving the first signal and activation by the user of the second sensing device, transmitting a second signal over a wireless network to a predetermined recipient.

### BRIEF DESCRIPTION OF THE DRAWINGS

Preferred and alternative embodiments of the present invention are described in detail below with reference to the following drawing figures:

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 illustrates a system according to an embodiment of the invention;

FIG. 4 illustrates a signaling device according to an embodiment of the invention;

FIG. 5 illustrates a system according to an alternative embodiment of the invention; and

FIGS. 6-7 are screenshots illustrating functionality of one or more embodiments of the invention.

### DETAILED DESCRIPTION OF THE PREFERRED EMBODIMENT

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

One or more embodiments of the invention can include or otherwise cooperate with a wearable, or otherwise portable, signaling device, a host electronic device, such as a smartphone or tablet device carried by the user, a software application that executes on the host device, a cloud-based web service, and police and/or personal emergency response operators (PEROs) who can assist the user. Furthermore, a collection of friends, family and/or other trusted entities (which, herein, may be collectively referred to as the “Guardian Network”) can be notified through various means as to the user's emergency status, location, and any other important or relevant information. In an embodiment, a user may opt to also call upon other users of the invention and Guardians who are not part of their personal Guardian Network, but who have opted to participate in what may be referred to herein as the “Safelet Community,” and who are in close geographic proximity to the user. The goal of an embodiment is to provide effective, easily accessible and easily executable personal emergency response services through the user of a worn signaling device, a host device carried by the user, and a cloud based web service which alerts and coordinates Guardian Network communications.

A signaling device according to at least one embodiment of the invention may include one or more of the following: a battery; a Bluetooth® 4.x low energy radio; a Bluetooth® 3.0 “classic” radio; two separate antennas (one for each respective radio); an alert detection/input method, which may include two push-button switches that must be pressed simultaneously; two microphone inputs to maximize coverage; a speaker device; an unbalanced mass (off-center-weight) vibration motor; a collection of 3 different-colored LED lights in close physical proximity to one another to maximize color mixing (e.g., an RGB LED); and an accelerometer to detect motion/movements/tapping.

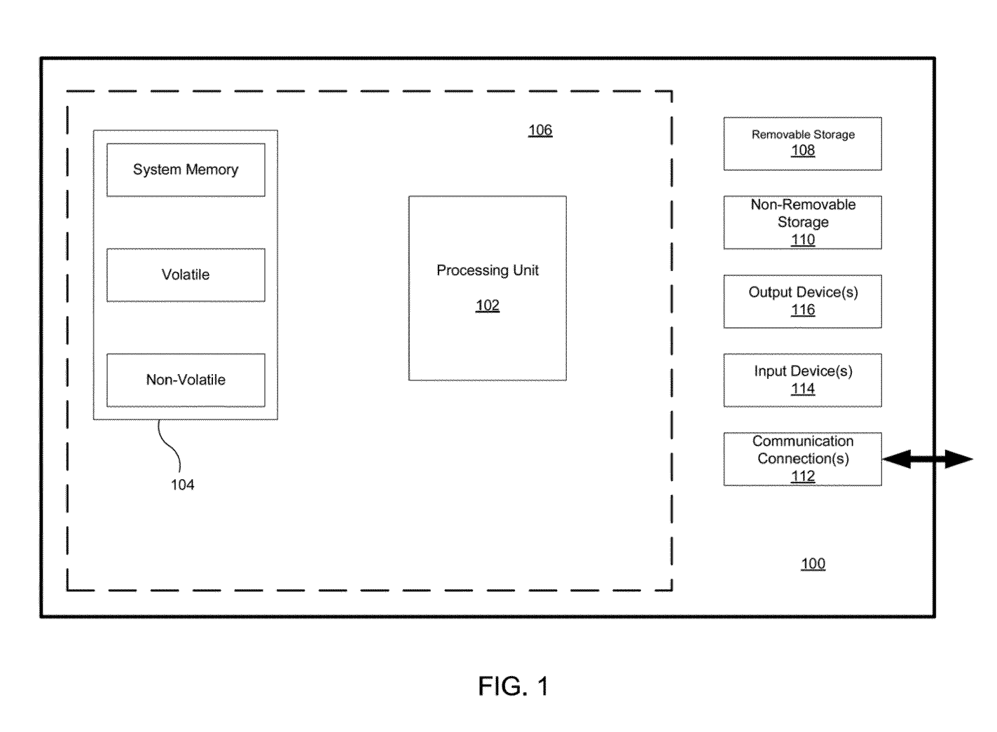

FIG. 1 illustrates an example of an electronic device 100 in which one or more embodiments of the invention may be implemented or with which one or more embodiments may cooperate. The electronic device 100, as illustrated, is an example of a suitable computing environment; however it is appreciated that other environments, systems, and devices may be used to implement various embodiments of the invention as described in more detail below.

Embodiments of the invention may be operational with numerous general-purpose or special purpose computing system environments or configurations. Examples of well-known computing systems, environments, and/or configurations that may be suitable for use with embodiments of the invention include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

Embodiments of the invention may be described in the general context of computer-executable instructions, such as program modules being executed by a computer. Generally, program modules include routines, programs, objects, components, data structures, etc. that perform particular tasks or implement particular abstract data types. Embodiments of the invention may also be practiced in distributed-computing environments where tasks are performed by remote processing devices that are linked through a communications network. In a distributed computing environment, program modules may be located in both local and remote computer storage media including memory storage devices. Additionally, the entity that may implement, or otherwise provide the ability to implement, elements of embodiments of the invention may be referred to herein as an “administrator.”

With reference to FIG. 1, an exemplary system for implementing an embodiment of the invention includes an electronic device 100. The electronic device 100 typically includes at least one processing unit 102 and memory 104.

Depending on the exact configuration and type of electronic device, memory 104 may be volatile (such as random-access memory (RAM)), nonvolatile (such as read-only memory (ROM), flash memory, etc.) or some combination of the two. This most basic configuration is illustrated in FIG. 1 by dashed line 106.

Additionally, the device 100 may have additional features, aspects, and functionality. For example, the device 100 may include additional storage (removable and/or non-removable) which may take the form of, but is not limited to, magnetic or optical disks or tapes. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

The device 100 may also include a communications connection 112 that allows the device to communicate with other devices. The communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio-frequency (RF), infrared and other wireless media. The term computer-readable media as used herein includes both storage media and communication media.

The device 100 may also have an input device 114 such as keyboard, mouse, pen, voice-input device, touch-input device, etc. Further, an output device 116 such as a display, speakers, printer, etc. may also be included. Additional input devices 114 and output devices 116 may be included depending on a desired functionality of the device 100.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

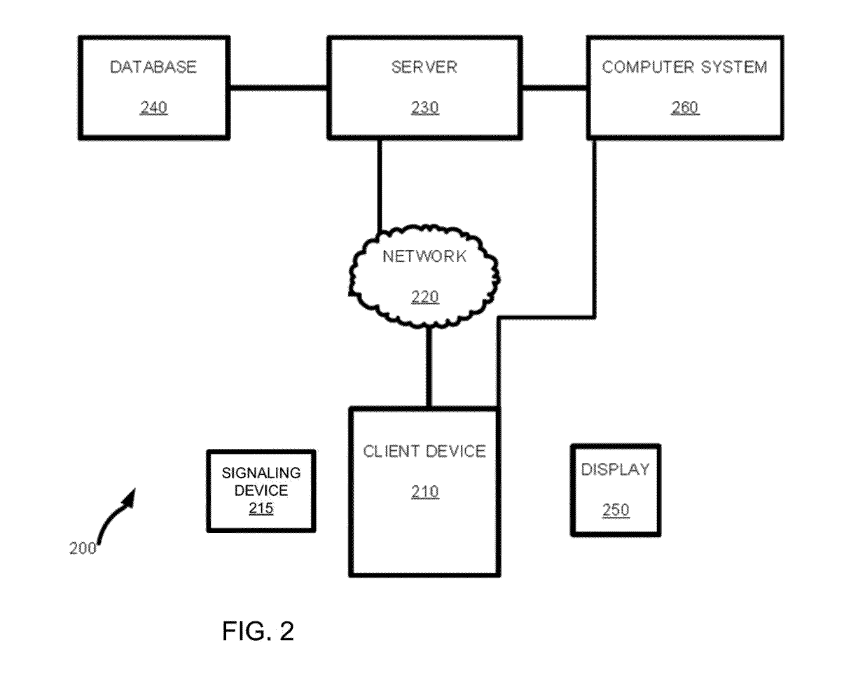

Referring now to FIG. 2, an embodiment of the present invention may take the form, and/or may be implemented using one or more elements, of an exemplary computer network system 200. The system 200 includes an electronic client, or host, device 210, such as a personal computer or workstation, tablet or smart phone, that is linked via a communication medium, such as a network 220 (e.g., the Internet), to an electronic device or system, such as a server 230. As will be discussed in greater detail herein, the system 200 may further include a signaling device 215 in electronic, preferably wireless, communication with client device 210. The server 230 may further be coupled, or otherwise have access, to a database 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers.

The client device 210, signaling device 215 and the server 230 may include all, more than or fewer than all of the features associated with the device 100 illustrated in and discussed with reference to FIG. 1. The client device 210 includes or is otherwise coupled to a computer screen or display 250. The client device 210 may be used for various purposes such as network- and local-computing processes.

The client device 210 is linked via the network 220 to server 230 so that computer programs, such as, for example, smart phone applications, running on the client device 210 can cooperate in two-way communication with server 230. The server 230 may be coupled to database 240 to retrieve information therefrom and to store information thereto. Database 240 may have stored therein data (not shown) that can be used by the server 230 to enable performance of various aspects of embodiments of the invention. The data stored in database 240 may include, for example, telephone numbers, call-recipient identities, locations visited by the user. Additionally, the server 230 may be coupled to the computer system 260 in a manner allowing the server to delegate certain processing functions to the computer system. In an embodiment, the client device 210 may bypass network 220 and communicate directly with computer system 260.

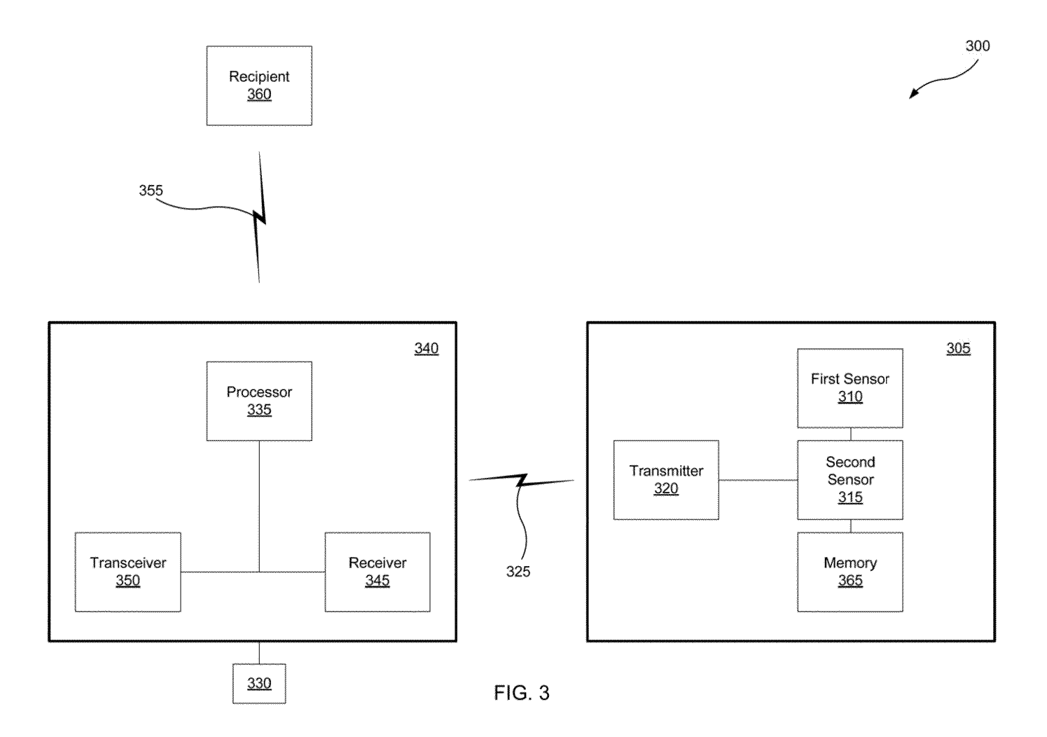

Referring now to FIG. 3, an emergency notification system 300 according to a first embodiment includes a signaling device 305 structurally identical to signaling device 215 illustrated in FIG. 2. The signaling device 305 includes a first activatable sensing device 310, such as a button or an accelerometer, a second activatable sensing device 315, such as a button, an electrical switch, a mechanical or capacitive sensor, or an accelerometer (i.e., a motion- and/or orientation-sensing device), and a transmitter 320 communicatively coupled to the first and second sensing devices. In alternative embodiments, the system 300 may include more than one such device 305. The transmitter 320 is configured to transmit a first signal 325 in response to activation by a user (not shown) of both the first and second sensing devices 310, 315. In an embodiment, the transmitter 320 transmits the first signal 325 only in response to simultaneous activation or activation in a specific predetermined pattern by the user of the first and second sensing devices 310, 315.

The system 300 further includes a computer-readable medium 330 on which are stored instructions that, once made accessible thereto, can be executed by a processor 335 of a host electronic device 340, which may be structurally identical to client device 210 illustrated in FIG. 2. The host device 340 may include a receiver 345, such as a Bluetooth® receiver, and a transceiver 350. The computer-readable medium 330 may or may not be included by the host device 340. The computer-readable medium 330 may include or be included by one or more of the server 230 and computer system 260.

By executing the instructions stored on medium 330, host device 340 is operable to receive the first signal 325 from the transmitter 320. Subsequently, and in response to receiving the first signal 325, the host device 340 transmits a second signal 355 over a wireless network (not shown), such as a cellular network, to a predetermined recipient 360. In an embodiment, the predetermined recipient 360 is an emergency-services provider, such as, for example, police, firefighters and ambulance services, as well as guardians (friends, family, etc.), discussed in greater detail below, and private corporate or security operators.

In an embodiment, the host device 340 is configured to determine the geographic location of the host device. By executing the instructions stored on medium 330 and associated with a software application according to an embodiment, host device 340 is operable to select, based on the determined geographic location, the ideal predetermined recipient 360 from a plurality of otherwise-available recipients.

In an embodiment, the signaling device 305 further includes a memory device 365 allowing the host device 340 to store data on the memory device.

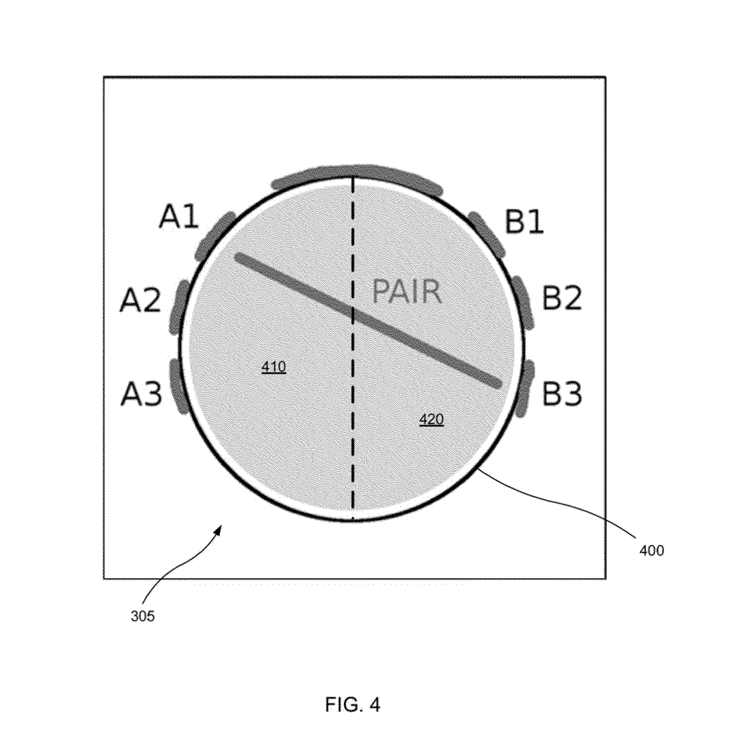

Referring now to FIG. 4, and in an embodiment, the signaling device 305 may include a circular housing 400 having first and second opposing sides 410, 420. A first set of buttons A1, A2, A3 is disposed on the first opposing side 410, and a second set of buttons B1, B2, B3 is disposed on the second opposing side 420. As alluded to above, the first signal 325 may be transmitted in response to simultaneous activation of opposing buttons from the respective button sets disposed on housing 400. As illustrated in FIG. 4, and for example, an opposing button pair may consist of button A1 and button B3, each of which may be disposed at an angle of approximately 180° from the other. Similarly, opposing button pairs may consist respectively of buttons A2-B2 and buttons A3-B1. In an embodiment, the first signal 325 may be transmitted in response to simultaneous activation of any button A1, A2, A3 of the first set with any button of the second set B1, B2, B3.

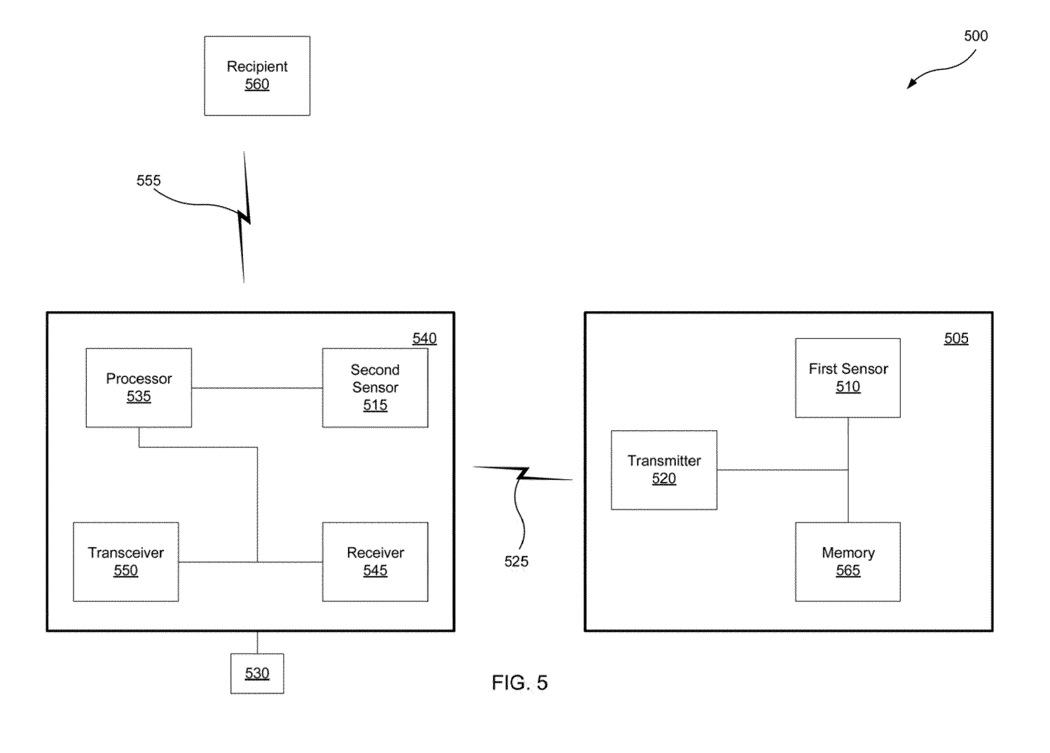

Referring now to FIG. 5, an emergency notification system 500 according to a second embodiment includes a signaling device 505 structurally identical to signaling device 215 illustrated in FIG. 2. The signaling device 505 includes a first activatable sensing device 510, such as a button (i.e., pressure sensor), an electrical switch, a mechanical or capacitive sensor, or an accelerometer, and a transmitter 520 communicatively coupled to the first sensing device. The transmitter 520 is configured to transmit a first signal 525 in response to activation by a user (not shown) of the first sensing device 510.

The system 500 further includes a computer-readable medium 530 on which are stored instructions that, once made accessible thereto, can be executed by a processor 535 of a host electronic device 540, which may be structurally identical to client device 210 illustrated in FIG. 2. The host device 540 may include a second activatable sensing device 515, such as a button, an accelerometer, or a microphone, a receiver 545, such as a Bluetooth® receiver, and a transceiver 550. The computer-readable medium 530 may or may not be included by the host device 540. The computer-readable medium 530 may include or be included by one or more of the server 230 and computer system 260.

By executing the instructions stored on medium 530 and associated with a software application according to an embodiment, host device 540 is operable to receive the first signal 525 from the transmitter 520. Subsequently, in response to receiving the first signal 525 and activation by the user of the second sensing device 515, the host device 540 transmits a second signal 555 over a wireless network (not shown), such as a cellular network, to a predetermined recipient 560. In an embodiment, the host device 540 transmits the second signal only in response to the user simultaneously activating the first sensing device 510 and speaking a predetermined word set into the microphone 515. In an alternative embodiment, the host device 540 transmits the second signal only in response to the user simultaneously or in a predetermined pattern activating the first sensing device 510 and activating the accelerometer 515 by moving the host device in a predetermined manner. In an embodiment, the predetermined recipient 560 is an emergency-services provider, such as, for example, police, firefighters and ambulance services, as well as guardians (friends, family, etc.), discussed in greater detail below, and private corporate or security operators.

In an embodiment, the host device 540 is configured to determine the geographic location of the host device. By executing the instructions stored on medium 530, host device 540 is operable to select, based on the determined geographic location, the ideal predetermined recipient 560 from a plurality of otherwise-available recipients.

In an embodiment, the signaling device 505 further includes a memory device 565 allowing the host device 540 to store data on the memory device.

An embodiment allows the user to invite people, through various means (e.g., email, social networks, SMS messages, etc.) to join their guardian network. Guardians may be people who accept this invitation and accept responsibility for responding to an alert triggered by the user, either through the host device 340, 540 directly, or by activating the signaling device 305, 505.

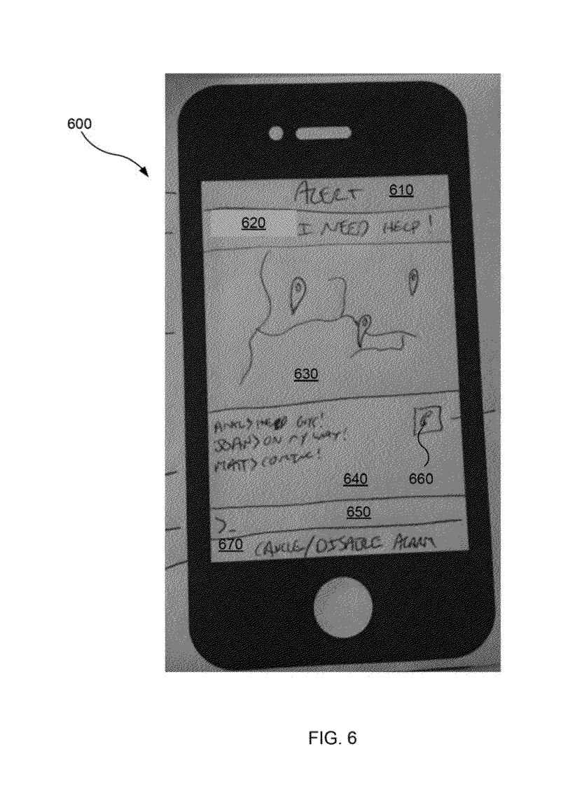

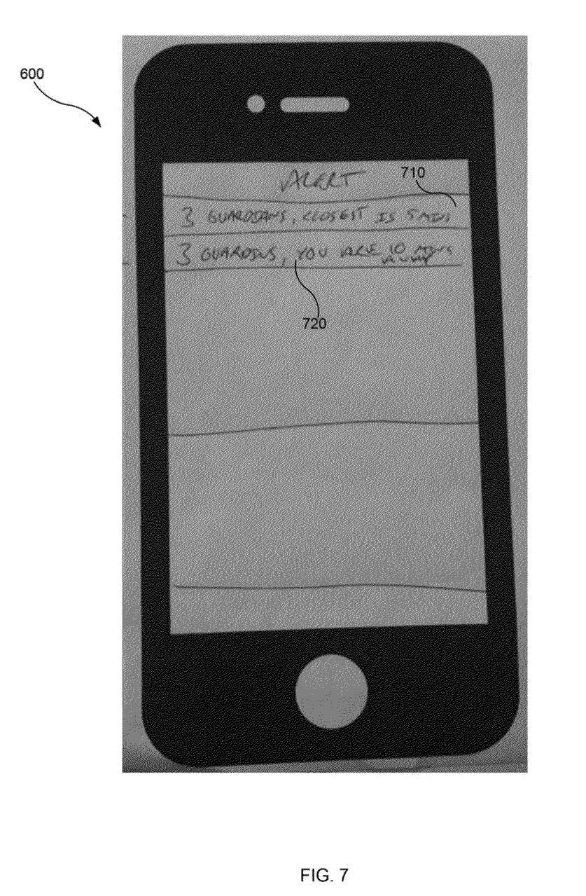

As is illustrated in FIGS. 6 and 7, guardians can receive alerts through various channels (e.g., an application running on a smart phone, SMS, email, etc.) and may be shown the user's alarm status and location. Additionally, guardians can coordinate through a map and chat interface that not only shows the location on a map of the user of a signaling device 305, 505, but also the location and status (e.g., ready to assist, on my way, can't respond, etc.) of each guardian. In this way, users can coordinate during an alarm condition, or possibly during a safe period, travel, etc. In an embodiment, the interface shows both a map of user locations along with a common chat interface on the screen at the same time. The use of color coordinated user icons that convey user status, the display of user locations on a map, and the common chat space, conveys a significant amount of information to the user at the same time on the same screen.

Specifically referring to FIG. 6, shown is an exemplary interface 600 that may be displayed to the user on a host device 340, 540. Interface 600 includes an application bar 610 indicating that the application according to an embodiment of the invention (which may be a manifestation of processor 335, 535 executing instructions stored on medium 330, 530) is in Alert mode. A status bar 620 indicates the current status of the user.

Referring to FIG. 7, different embodiments of status bar 620 may present relevant information including the number of guardians responding to an alarm generated by the user via system 300, 500, status of the closest guardian's estimated time of arrival, etc. For example, status bar 710 illustrates the display to the user of system 300, 500 when one or more guardians are engaged in responding to the alert, showing the number of guardians responding and the geographic and/or time distance away of the closest guardian. Status bar 720 illustrates the display to the guardian when engaged in responding to the alert, showing the number of guardians responding and the viewing guardian's geographic and/or time distance away from the user.

Referring back to FIG. 6, a map section 630 illustrates the user of system 300, 500 and guardians all on the same map. In an embodiment, the user will always be centered in the map. A chat area 640 allows a user to see an ongoing discussion between all people involved in the alert response, including the user, guardians, and possibly PEROs (operators, security staff, etc.) discussed in greater detail below. A chat prompt 650 allows users to type their responses to the chat communications. A group call button 660 can enable a user to initiate a phone call to a randomized conference call service number set up specifically for this alert. Alternatively, it could also allow for VoIP or data based voice conferencing.

In an embodiment, a user may employ a personal emergency response operator (PERO) to respond to alerts. The PERO can have the ability to directly receive video from all cameras available on the user's host device 340, 540 and/or signaling device 305, 505, as well as communicate via a two-way audio connection. Additionally, the PERO can also be able to communicate with and coordinate the guardian network, public response services like local police, fire, medical response teams, and private security departments and firms.

Another embodiment offers users the ability to increase safety by participating in the “Safelet Community.” This community platform allows users to provide assistance in emergency situations within their local geographic area, regardless of relationship to the victim. With the community platform, users have the ability to summon help not only from their friends, but other Safelet Community members as well. During an emergency, Safelet users and Guardians alike can receive emergency alerts from any Safelet user which is geographically local to the recipient.

The signaling device 305, 505 can be worn by the user and may be integrated into several different forms according to various embodiments, including but not limited to: a bracelet or watch, a necklace, a pendant, a broach, a ring, a belt, a purse strap, etc.

In an embodiment, the signaling device 305, 505 can maintain a connection with the host device 340, 540 using Bluetooth® Low Energy technology. This connection can relay device and battery status from the signaling device 305, 505 to the host device 340, 540, and target-from the host device party telephone number updates to the signaling device for storage thereon in memory 365, 565.

The software application according to an embodiment running on the host device 340, 540 can determine the user's most accurate geolocation coordinates possible using any available technologies on the host device. This could include technologies such as WiFi geodata references, cell ID triangulation, GPS and GLONASS satellite location technologies, etc.

The software application can enable the host device 340, 540 to periodically communicate user status and location to a cloud-based web service that may be associated with, for example, server 230. Additionally, the software application can enable the host device 340, 540 to monitor dialing preferences as specified by the user as well as current public emergency telephone numbers for the user's current geolocation. For example, if the user were to travel from New York to Amsterdam, the software application may monitor the user's location as determined by the host device 340, 540 and update the memory 365, 565 of the signaling device 305, 505 such that the public emergency services number that may be dialed in the event of an emergency may be changed from 911 to 112, and back again once the user landed back home in New York.

If the user should separate their host device 340, 540 and signaling device 305, 505 by more than a few feet, an alert of can be provided to the user from both devices. This alert could include light, sound, tactile vibration, or a combination of all three.

In an embodiment, the signaling device 305, 505 monitors and detects one or more actions taken by the user to trigger activation of the system 300, 500. An action that may lead to the transmission of a signal may include (but is not limited to) pinching or squeezing a bracelet band, providing biofeedback signals that indicate panic or struggle, breaking of a circuit as may happen in the tearing of a purse strap or clothing.

Upon signaling device 305, 505 activation, a cascade of actions can occur on both the signaling device and the host device 340, 540 that can result in the user's Guardian Network being alerted to the emergency. Optionally, nearby members of the Safelet Community could also be alerted, and an optional phone call may be placed to emergency services, a Safelet response operator (PERO), or a designated family member. This cascade of actions includes the following optionally advantageous elements:

The signaling device 305, 505 can communicate the alert status to the host device 340, 540.

Upon receipt of the alert from the signaling device 305, 505, the host device 340, 540, executing instructions according to an embodiment, can communicate the alert status and the user's current location to the cloud-based web service.

When the user's alert status is received from the host device 340, 540 by the web service, the web service can communicate the user's alert status to that user's guardian network via mobile push notification, SMS text message, email alert, telephone call, and possibly other methods as per each guardian's contact preferences.

The signaling device 305, 505 can connect to the host device 340, 540 using a Bluetooth® 3.0 or earlier specification radio and activate both the Hands Free Profile and Headset Profile.

Once the Bluetooth® 3.0 radio is connected, the signaling device 305, 505 can initiate a telephone call from the host device 340, 540 to the appropriate party using the Hands Free Profile and optionally connect telephone call audio to a microphone and speaker in the signaling device itself.

For the duration of the emergency situation, the signaling device 305, 505 can maintain a Low Energy connection with the host device 340, 540, communicating battery and proximity status with the host device. The host device 340, 540 can also periodically update the cloud based web service with the user's alert status, telephone call status (on the phone with 911, 112, etc.), the user's geolocation information, and proximity and battery status of the signaling device 305, 505.

Should the user's signaling device 305, 505 move out of range of the host device 340, 540 during an alert situation, the 3.0 radio can be powered down and the signaling device can go into a low-power emergency alert state.

If a user should be separated from their host device 340, 540 while in an alert state, or the user activates the emergency alert state while separated from the host device, the signaling device 305, 505 can enter into a low power emergency alert state. In this state, the signaling device 305, 505 begins periodically transmitting Low Energy emergency alert advertising packets at maximum power.

Any host device 340, 540 in receive range of any signaling device 305, 505 operating in low power emergency alert mode, that is also running the software app or a 3^{rd} party software package capable of receiving and interpreting these emergency alert advertising packets, can immediately report that signaling device's unique address, battery status, and all other transmitted information along with the host device's geolocation information to the cloud based web service.

Optionally, the owner of the host device 340, 540 may be alerted to the fact that they are in close proximity to an emergency and could assist by passively remaining in the area or possibly by using RSSI signal strength indicators to guide the host device closer to the active signaling device 305, 505. Multiple host devices 340, 540 running software applications according to an embodiment may also be used to triangulate the position of the active signaling device 305, 505 either passively without the host device's owner being alerted, or actively alerting and recruiting the host device's owner in assisting in the location efforts.

Personal information regarding the owner of the signaling device 305, 505 may be presented to third party host device owners running the software application according to an embodiment on their devices. This information may include the signaling device 305, 505 owner's photo, first name, and other information relevant to locating the signaling device owner. Optionally, the third party host device 340, 540 owner may also be connected with the signaling device 305, 505 owner's guardian network in order to establish critical information exchange between the third party host device owner and the guardians.

Given the appropriate permissions granted to a guardian within the service according to an embodiment, a guardian may initiate an emergency call-back. The software application according to an embodiment running on the user's host device 340, 540 can receive a remote command from that guardian by way of SMS text message, push notification, web service API message, or some other method where the remote command is received by the user's host device. The host device 340, 540 may then communicate the call-back command along with the target call-back telephone number to the signaling device 305, 505 via low energy radio protocols. The signaling device 305, 505 may then power up the Bluetooth® 3.0 radio and connect the Hands Free and optionally the Headset profiles to the host device in order to initiate the desired telephone call. This may allow a guardian to directly establish a user-initiated telephone call, which may allow the guardian to attempt to communicate with the user, listen for audio clues as to the user's current mental state, etc.

Users of signaling devices 305, 505 may check-in, recording their GPS location and current status as a check-in event. Guardians would then receive non-emergency check-in event notifications which contain this check-in information. Guardians may also issue a check-in request of the user which would result in a non-emergency notification for the user of a signaling device 305, 505. The user of the signaling device 305, 505 would be made aware that one of their Guardians would like to receive a check-in update from them.

One or more embodiments of the invention may be implemented as a system of jewelry where the electronic components of the signaling device 305, 505 can be built into a base module and various decorative pieces can be affixed to it in such a manner that they are interchangeable and replaceable at will by the user.

Methods of allowing interchangeable decorative pieces (“skins”) include but are not limited to:

a clamshell design which allows two or more decorative pieces to fully encase a signaling device 305, 505 base module;

a decorative face plate which attaches overtop of a watch-like signaling device 305, 505 base module;

a decorative encircling plate around a base necklace signaling device 305, 505 module.

From the foregoing, it will be appreciated that specific embodiments of the personalized feed system have been described herein for purposes of illustration, but that various modifications may be made without deviating from the spirit and scope of the invention. Accordingly, the invention is not limited except as by the appended claims.

What is claimed is:

1. An emergency notification system, comprising:
a signaling device, comprising:
a first activatable sensing device,
a second activatable sensing device, and
a transmitter communicatively coupled to the first and second sensing devices, wherein the transmitter is configured to transmit a first signal in response to activation by a user of both the first and second sensing devices; and
a computer-readable medium on which are stored instructions that, when executed by a processor of an electronic device including a receiver and a transceiver, enable the electronic device to perform a method comprising the steps of:
receiving the first signal from the transmitter; and
in response to receiving the first signal, transmitting a second signal over a wireless network to a predetermined recipient.

2. The system of claim 1, wherein the first sensing device comprises a first button.

3. The system of claim 2, wherein the second sensing device comprises a second button.

4. The system of claim 3, wherein the transmitter transmits the first signal only in response to simultaneous activation by the user of the first and second buttons.

5. The system of claim 1, wherein the second sensing device comprises an accelerometer.

6. The system of claim 1, wherein the electronic device is configured to determine the geographic location of the electronic device, and the method further comprises the step of selecting, based on the determined geographic location, the predetermined recipient from a plurality of recipients.

7. The system of claim 1, wherein:
the signaling device further comprises a memory device; and
the method further comprises storing data on the memory device.

8. The system of claim 3, wherein the signaling device further comprises a circular housing having first and second opposing sides, the first button is disposed on the first opposing side and the second button is disposed on the second opposing side.

9. The system of claim 8, wherein the first button is at an angle of approximately 180° from the second button.

10. The system of claim 1, wherein the predetermined recipient is an emergency-services provider.

11. An emergency notification system, comprising:
a signaling device, comprising:
a first activatable sensing device, and
a transmitter communicatively coupled to the first sensing device, wherein the transmitter is configured to transmit a first signal in response to activation by a user of the first sensing device; and
a computer-readable medium on which are stored instructions that, when executed by a processor of an electronic device including a receiver, a second activatable sensing device and a transceiver, enable the electronic device to perform a method comprising the steps of:
receiving the first signal from the transmitter; and
in response to receiving the first signal and activation by the user of the second sensing device, transmitting a second signal over a wireless network to a predetermined recipient.

12. The system of claim 11, wherein the first sensing device comprises a button.

13. The system of claim 12, wherein the second sensing device comprises a microphone.

14. The system of claim 13, wherein the electronic device transmits the second signal only in response to the user simultaneously activating the button and speaking a predetermined word set into the microphone.

15. The system of claim 11, wherein the second sensing device comprises an accelerometer.

16. The system of claim 11, wherein the electronic device is configured to determine the geographic location of the electronic device, and the method further comprises the step of selecting, based on the determined geographic location, the predetermined recipient from a plurality of recipients.

17. The system of claim 11, wherein:
the signaling device further comprises a memory device; and
the method further comprises storing data on the memory device.

18. The system of claim 11, wherein the predetermined recipient is an emergency-services provider.
